(19) United States
(12) Patent Application Publication
(10) Pub. No.: US 2026/0241945 A1
(43) Pub. Date: Aug. 20, 2026

(54) PARAMETER TUNING TOOL

(71) Applicant: Fox Factory, Inc., Duluth, GA (US)

(72) Inventors: Scott Malinowski, Santa Cruz, CA (US); Robert Stanford, Alpharetta, GA (US); Fariz Khandker, Buford, GA (US); Mike Day, Hoschton, GA (US)

(73) Assignee: Fox Factory, Inc., Duluth, GA (US)

(21) Appl. No.: 19/240,972

(22) Filed: Jun. 17, 2025

Related U.S. Application Data
(60) Provisional application No. 63/758,893, filed on Feb. 14, 2025.

(51) Int. Cl. B60W 50/08; B60G 17/015; B60W 10/22

(52) U.S. Cl. CPC B60W 50/085; B60G 17/015; B60W 10/22

(57) ABSTRACT

A vehicle parameter tuning system. The vehicle parameter tuning system includes a non-vehicle specific base model. The non-vehicle specific base model configured to apply parameters to a vehicle. A graphical user interface module configured to provide at least one graphical user interface to enable a user of the vehicle parameter tuning system to apply the parameters to the vehicle. The non-vehicle specific base model is also configurable for use with a specific version of the vehicle.

### CROSS-REFERENCE TO RELATED APPLICATIONS (PROVISIONAL)

This application claims priority to and the benefit of U.S. Provisional Patent Application No. 63/758,893, filed on Feb. 14, 2025, entitled “PARAMETER TUNING TOOL” by Malinowski et al., and assigned to the assignee of the present application, the disclosure of which is hereby incorporated by reference in its entirety.

### FIELD OF THE INVENTION

Embodiments of the invention generally relate to methods and apparatus for use in vehicle parameter tuning, testing of vehicle parameters, and reporting of operational details related to vehicle parameters.

### BACKGROUND OF THE INVENTION

Vehicle parameter tuning is often a complex, iterative, time-consuming operation.

### BRIEF DESCRIPTION OF THE DRAWINGS

FIG. 1 is a schematic representation of various aspects of the present parameter tuning tool, in accordance with an embodiment of the present invention.

FIGS. 2A-2C include graphical depictions of various aspects of graphical user interfaces of the present parameter tuning tool, in accordance with an embodiment of the present invention.

FIGS. 3A-3B include graphical depictions of various aspects of importing components of the parameter tuning tool, in accordance with an embodiment of the present invention.

FIG. 4 is a graphical depiction of tuning controls and a graphical user interface therefore provided by the parameter tuning tool, in accordance with an embodiment of the present invention.

FIG. 5 is a graphical depiction of vehicle operation results based upon various tuning parameters provided by the parameter tuning tool, in accordance with an embodiment of the present invention.

FIG. 6 is a graphical depiction of operations and a graphical user interface therefore provided by the parameter tuning tool, in accordance with an embodiment of the present invention.

FIG. 7 is a graphical depiction of vehicle operation results based upon various tuning parameters provided by the parameter tuning tool, in accordance with an embodiment of the present invention.

FIGS. 8-11 are graphical depictions of a series of vehicle operation results and user adjustable tuning parameters provided by the parameter tuning tool, in accordance with an embodiment of the present invention.

FIG. 12 is a schematic diagram of a vehicle parameter tuning system which graphically illustrates and summarizes various features and components of the present parameter tuning tool, in accordance with an embodiment of the present invention.

FIG. 13 is a schematic diagram of a computer system which graphically illustrates and summarizes various features and components which can be included within, utilized by, and/or used in conjunction with the present parameter tuning tool, in accordance with an embodiment of the present invention

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

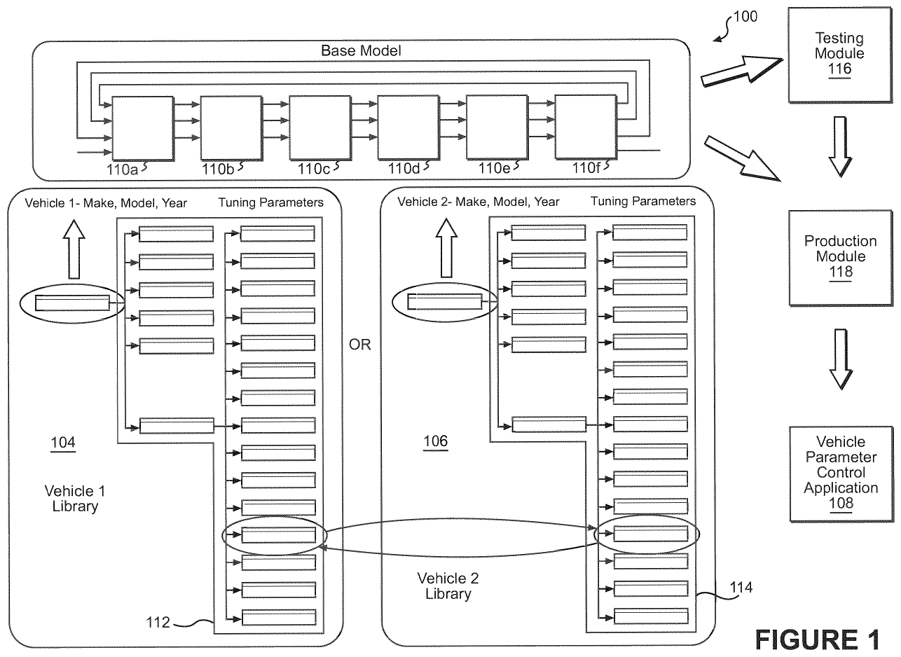

Referring now to FIG. 1, the present parameter tuning tool 100 provides a generic solution for enabling real-time algorithm tuning on, for example, a target vehicle's ECU and the present parameter tuning tool 100 provides real-time data display. The present parameter tuning tool 100 enables parameter tuning and adjustments to the parameter tuning tool 100 itself via a mobile device such as, for example, an iOS or Android tablet/mobile phone and the like. It should be noted that the present parameter tuning tool 100 enables tuning of various vehicle parameters and/or various parameters of components used with or coupled with a vehicle. Moreover, the present parameter tuning tool 100 also enables tuning of the interaction of a vehicle with one or more components used with or coupled to the vehicle. For purposes of brevity and clarity, the following discussion will often refer to a “vehicle parameter” or to “vehicle parameters”. In the following discussion, it should be noted that the terms “vehicle parameter” or “vehicle parameters” are intended to include at least one or more of: a vehicle parameter; a parameter of a component used with or coupled with a vehicle; or an interaction of a vehicle with one or more components used with or coupled with the vehicle.

As shown in FIG. 1, the present parameter tuning tool 100 includes a Base Model 102 which, in one embodiment, is not specific to any particular vehicle or version of a specific vehicle. That is, the Base Model 102 of the present parameter tuning tool 100 is not limited to use with a one type of vehicle or specific version of a vehicle. That is, in various embodiments, the present parameter tuning tool 100 can be used with any vehicle and/or any vehicle parameter control application. Base Model 102 includes various fundamental tuning parameters, for example, fundamental suspension tuning parameters, which are likely to be utilized by many, or all vehicle parameter control applications such as, for example vehicle parameter control application 108.

In embodiments of the present invention, the Base Model 102 of the present invention includes vehicle parameter values (schematically represented as 110a-110f in FIG. 1) which are typically found in most vehicles. Hence, in various embodiments, Base Model 102 of the present invention includes a generic common master model of vehicle parameters which are likely to be common to most vehicles. As a result, Base Model 102 of the present invention eliminates the need to hardcode such commonly used vehicle parameters for each new vehicle or for a new model of a particular vehicle.

Referring still to FIG. 1, the present parameter tuning tool is configured to receive input from at least one parameter library, or parameter data dictionary. Such parameter libraries are depicted as vehicle 1 library 104 and vehicle 2 library 106 in FIG. 1. Importantly, in various embodiments, the Base Model 102 of the present parameter tuning tool is configured to accept any parameter library corresponding to the specific vehicle whose parameters a user of the present parameter tuning tool wishes to configure. Thus, in embodiments of the present invention, Base Model 102 is used in conjunction with vehicle 1 library 104 and/or vehicle 2 library 106 to aggregate the necessary common and the necessary vehicle-specific tuning parameters for a given vehicle and/or a given vehicle make and model. Referring still application specific parameters

As shown in FIG. 1, two separate parameter libraries are show. The first parameter library, vehicle 1 library 104, is designed and created for a “Vehicle 1” having a particular make, model and year. The second parameter library, vehicle 2 library 106, is designed and created for a “Vehicle 2” having a particular make, model and year which differs, at least slightly, from the particular make, model and year of Vehicle 1. It should be noted that in various embodiments of the present invention, any portion or all of the first parameter library, vehicle 1 library 104, can be shared with or “re-used”, in part or in whole, in the second parameter library, vehicle 2 library 106. Similarly, any portion or all of the second parameter library, vehicle 2 library 106, can be shared with or “re-used”, in part or in whole, in the first parameter library, vehicle 1 library 104.

As depicted in FIG. 1, in one example, the Base Model 102 of the present parameter tuning tool 100 will utilize the first parameter library, vehicle 1 library 104, for a “Vehicle 1” to import and ultimately tune the parameters of Vehicle 1. In various other embodiments a plurality of parameter data libraries are used with the Base Model 102 to tune parameters of a single vehicle. It should be noted that such tuning of vehicle parameters may also be referred to as configuring vehicle parameters, testing vehicle parameters, importing vehicle parameters and the like.

In various embodiments of the present invention, the various application specific parameter values comprising vehicle 1 library 104 and/or vehicle 2 library 106 are stored in specialized containers referred to as data dictionaries. Such data dictionaries are schematically depicted in FIG. 1 as data dictionaries 112 in vehicle 1 library 104, and as data dictionaries 114 in vehicle 2 library 106. Additionally, in embodiments of the present invention, the application specific parameter tuning values comprising the data dictionaries have settings which ultimately allow the application specific parameter tuning values to be accessed by an application program interface of the vehicle parameter control application 108. For example, in one embodiment, the present parameter tuning tool 100 imports vehicle parameters from vehicle 1 library 104 and/or vehicle 2 library 106 in the form of a comma-separated values (CSV) file, or any other suitable import file type, protocol or industry standard.

As will be discussed in further detail below, in various embodiments of the present parameter tuning tool 100, the application specific parameter tuning values comprising vehicle 1 library 104 and/or vehicle 2 library 106 also include additional properties that allow the present parameter tuning tool 100 to determine the type of user interface (UI) presented by the present parameter tuning tool 100. More specifically, the present parameter tuning tool 100 may dictate that UIs comprised of, for example, sliders, tables, toggle switches and the like are to be utilized during the vehicle parameter tuning process. Additionally, in various embodiments, the properties of the application specific parameter tuning values comprising, for example, vehicle 1 library 104 and/or vehicle 2 library 106 will include properties which determine the UIs which are ultimately presented to a vehicle user when the vehicle user interacts with vehicle parameter control application 108. It should be noted that the present parameter tuning tool 100 is well suited to presenting any of a myriad of possible UI elements and/or graphic user interfaces (GUIs) for use during the vehicle parameter tuning process and/or for subsequent presentation to a vehicle user to enable the vehicle user to interact with, for example, vehicle parameter control application 108.

Further, in various embodiments of the present parameter tuning tool 100, UI elements are pre-defined in the Base Model 102 and/or in the specific vehicle data dictionaries/parameter libraries (e.g., vehicle 1 library 104 and/or vehicle 2 library 106). Also, in various embodiments of the present parameter tuning tool 100, such UI elements themselves (and/or the specific vehicle data dictionaries/parameter libraries) automatically drive creation and/or automatic generation of at least one graphical user interface in real-time. That is, in various embodiments of the present parameter tuning tool 100, the GUI self-populates instead of requiring an additional function (e.g., a separate drag/drop function) to link UI elements to the present parameter tuning tool 100.

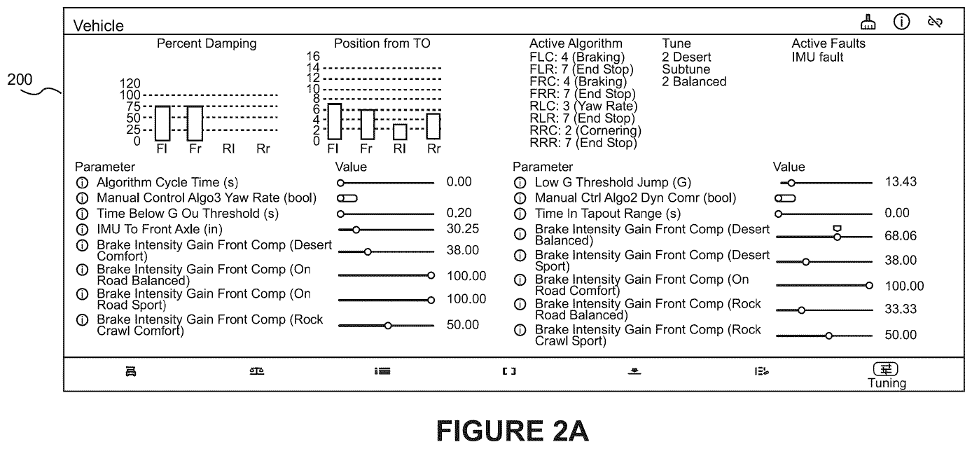

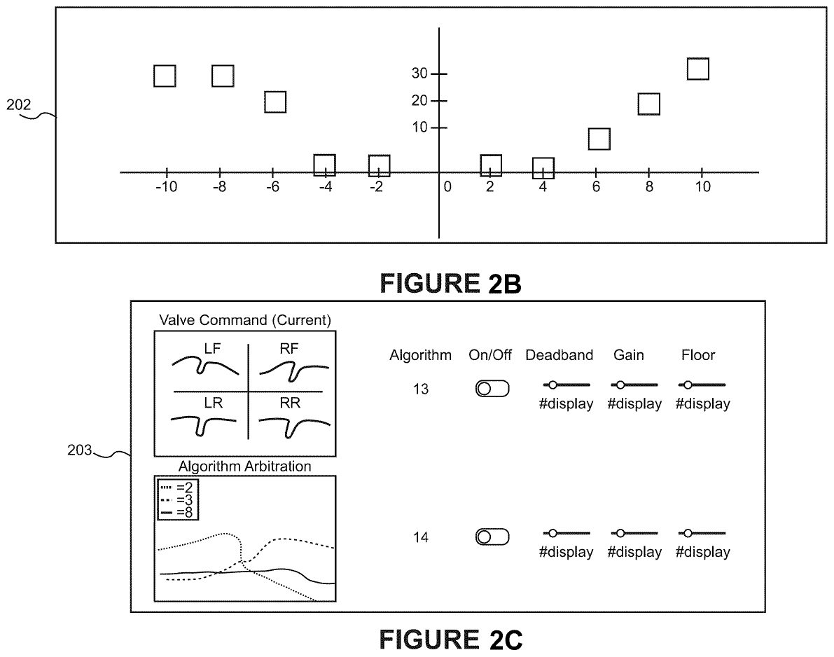

The present parameter tuning tool 100 enables a user to tune vehicle parameters to a desired level and/or state. In various embodiments, the present parameter tuning tool 100 generates a tuning application program interface (API), which exposes, for example, a mobile application or a tablet application to allow the vehicle parameters to be calibrated/tuned. Moreover, in various embodiments, the present parameter tuning tool 100 generates various data dashboards (as will be discussed below in conjunction with FIGS. 2A, 2B, 2C, 3A, 3B and 4-11) using source code stored in the mobile application and/or the tablet application.

Referring now to FIG. 2A, an example of a UI 200 for tuning vehicle parameters in accordance with the present parameter tuning tool 100 is provided. As shown in FIG. 2A, various sliders are utilized to adjust/tune desired vehicle parameters. In FIG. 2B, another example of a UI 202 for tuning vehicle parameters in accordance with the present parameter tuning tool 100 is provided. As shown in FIG. 2B, a graph having a horizontal axis and a vertical axis can be utilized to adjust/tune desired vehicle parameters in accordance with one embodiment of the present parameter tuning tool 100. Moreover, in FIG. 2C, yet another example of a UI 204 for tuning vehicle parameters in accordance with the present parameter tuning tool 100 is provided. As shown in FIG. 2C, various graphs and charts in combination with various buttons and sliders are utilized to adjust/tune desired vehicle parameters in accordance with one embodiment of the present parameter tuning tool 100. It should be noted that FIGS. 2A, 2B and 2C are provided to illustrate specific UI implementations which are well suited to use with the present parameter tuning tool 100. It should further be noted that, although FIGS. 2A, 2B and 2C are provided as specific examples of UIs for tuning vehicle parameters, the present parameter tuning tool 100 is well suited to use with, or to generating, any of numerous types of UIs to enable tuning of various vehicle parameters, and that the present parameter tuning tool 100 is not limited to use with only a single UI or with any specific type of UI.

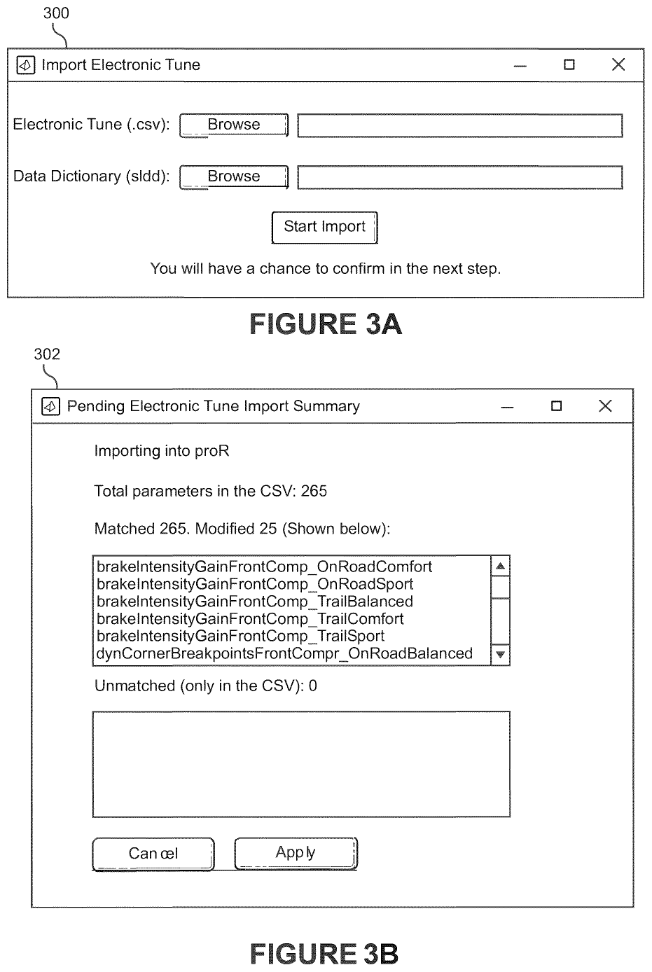

Referring now to FIG. 3A, an additional example of a UI 300 for tuning vehicle parameters in accordance with the present parameter tuning tool 100 is provided. More specifically, UI 300 is used, in the present parameter tuning tool 100, to import an electronic tune or set of previously defined vehicle parameter settings.

With reference next to FIG. 3B, an additional example of a UI 302 for tuning vehicle parameters in accordance with the present parameter tuning tool 100 is provided. More specifically, UI 302 is used, in the present parameter tuning tool 100, to provide a summary/analysis of the imported electronic tune or set of previously defined vehicle parameter settings such that a user of the present parameter tuning tool 100 is able to approve or deny any of the imported vehicle parameter settings. As mentioned above with respect to FIGS. 2A, 2B and 2C, it should be noted that, although FIGS. 3A and 3B are provided as specific examples of UIs for importing and accepting/denying such imported vehicle parameters, the present parameter tuning tool 100 is well suited to use with, or to generating, any of numerous types of UIs to enable the importation and/or approving/denying of such various vehicle parameters. That is, the present parameter tuning tool 100 is not limited to use with only a single UI or with any specific type of UI for importing and accepting/denying, or for adjusting/tuning of, such imported vehicle parameters.

Referring still to FIGS. 3A and 3B, the present parameter tuning tool 100 also includes, in various embodiments, an Electronic Vehicle Parameter Tune feature and a Save/Import/Export functionality which operates in conjunction with the Electronic Vehicle Parameter Tune feature. In such embodiments, previously determined tunes for various vehicle parameters can be uploaded to the cloud for seamless integration back into the present parameter tuning tool 100 for deployment. Also, various embodiments of the present parameter tuning tool 100 enable efficient tuning of, for example, a model-defined suspension system (e.g., a Modal, Semi-active and/or an Active suspension system).

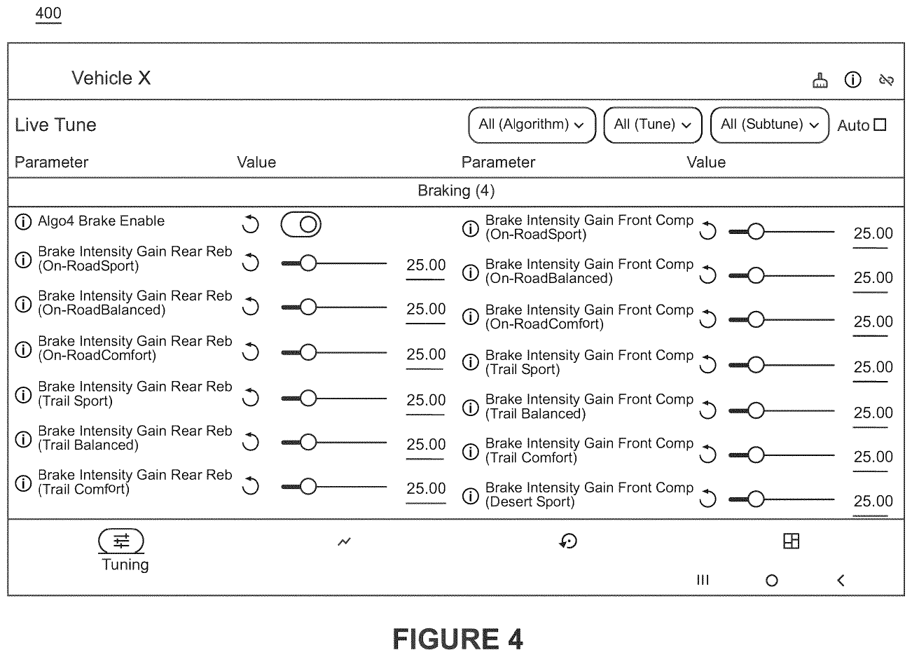

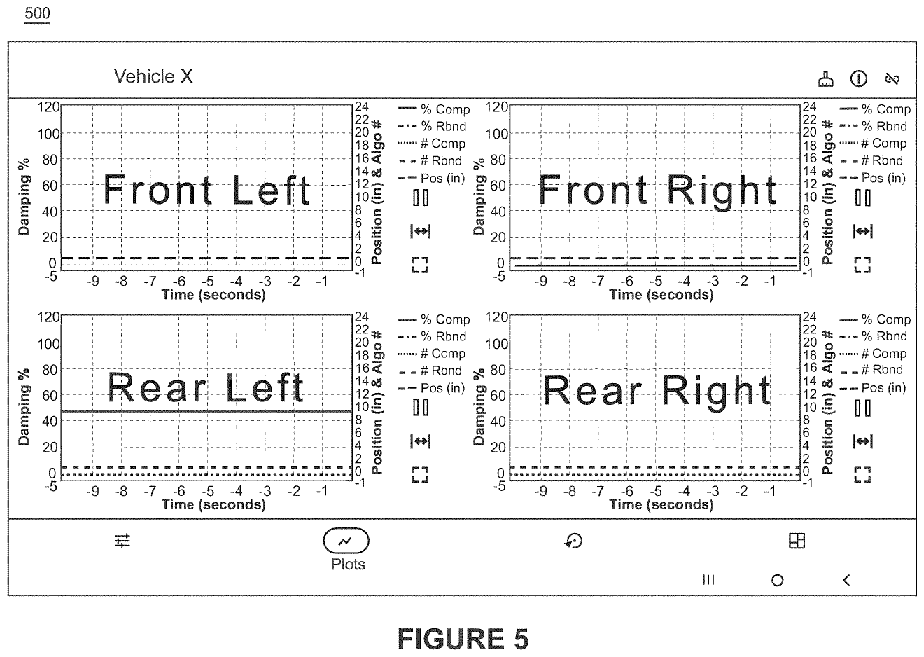

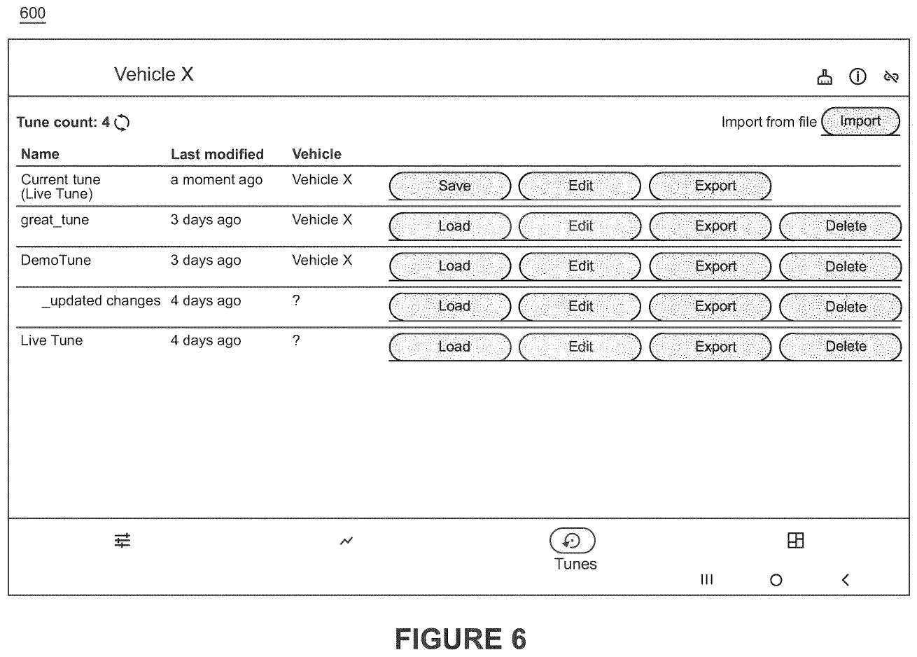

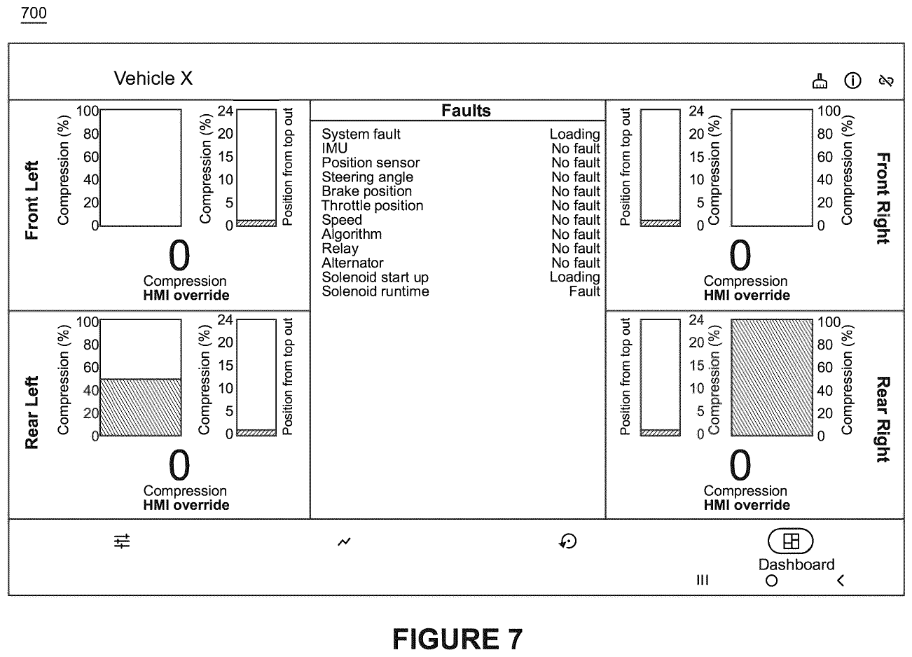

With reference now to FIGS. 4-7, the present parameter tuning tool 100 also provides a user with data corresponding to a particular tuning of the vehicle parameters. Specifically, UI 400 allows a user of the present parameter tuning tool 100 to visually analyze, adjust/tune and/or compare various vehicle parameters such as, for example, vehicle braking parameters. Moreover, UI 400 allows a user of the present parameter tuning tool 100 to visually ascertain is certain vehicle parameters (e.g., vehicle braking parameters) are enabled and the particular value/setting for the respective vehicle parameters. Similarly, in FIG. 5, UI 500 allows a user of the present parameter tuning tool 100 to visually analyze, adjust/tune and/or compare the vehicle parameters corresponding to the front right tire, the front left tire, the rear right tire and the rear left tire. As a result, a user of the present parameter tuning tool 100 can re-tune or adjust the vehicle parameters to obtain a desired result for each of the front right tire, the front left tire, the rear right tire and the rear left tire. In FIG. 6, UI 600 allows a user of the present parameter tuning tool 100 to visually analyze, adjust/tune, compare, save, edit, export, load or delete various vehicle parameter tunes for a given vehicle (i.e., vehicle X in UI 600). In FIG. 7, UI 700 allows a user of the present parameter tuning tool 100 to visually analyze, adjust/tune and/or compare the vehicle suspension parameters corresponding to the front right tire, the front left tire, the rear right tire and the rear left tire. As a result, a user of the present parameter tuning tool 100 can re-tune or adjust the vehicle parameters to obtain a desired suspension/compression result for each of the front right tire, the front left tire, the rear right tire and the rear left tire. As mentioned above with respect to FIGS. 2A, 2B and 2C, it should be noted that, although FIGS. 4-7 are provided as specific examples of UIs providing data corresponding to a particular tuning and/or predefined tune of various vehicle parameters, the present parameter tuning tool 100 is well suited to use with, or to generating, any of numerous types of UIs to provide data corresponding to a particular tuning and/or a predefined tune of various vehicle parameters. That is, the present parameter tuning tool 100 is not limited to use with only a single UI or with any specific type of UI for providing data corresponding to, or for adjusting/tuning of, a particular vehicle parameter tune and/or a setting for one or more vehicle parameters.

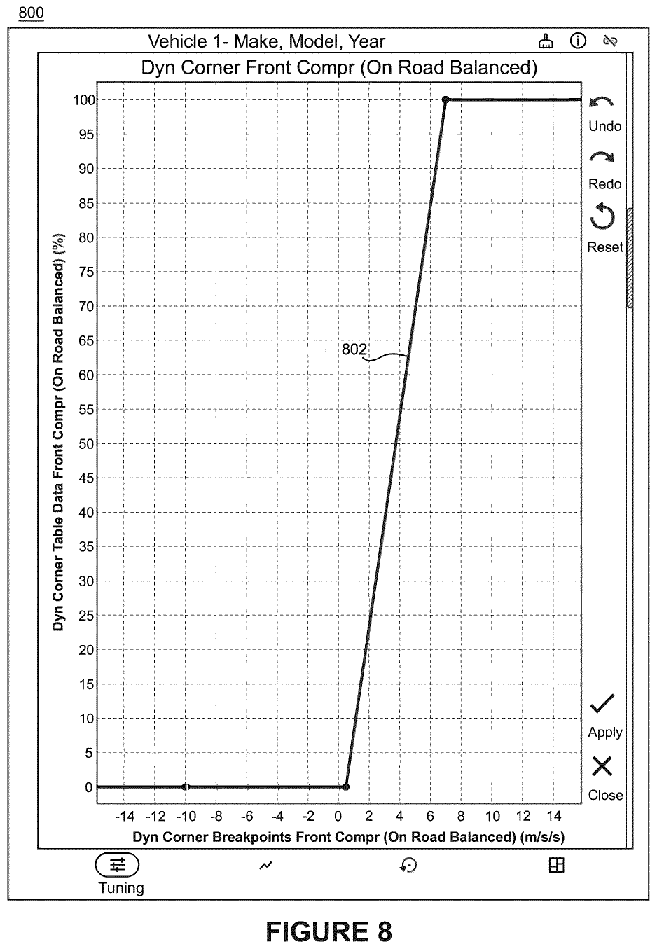

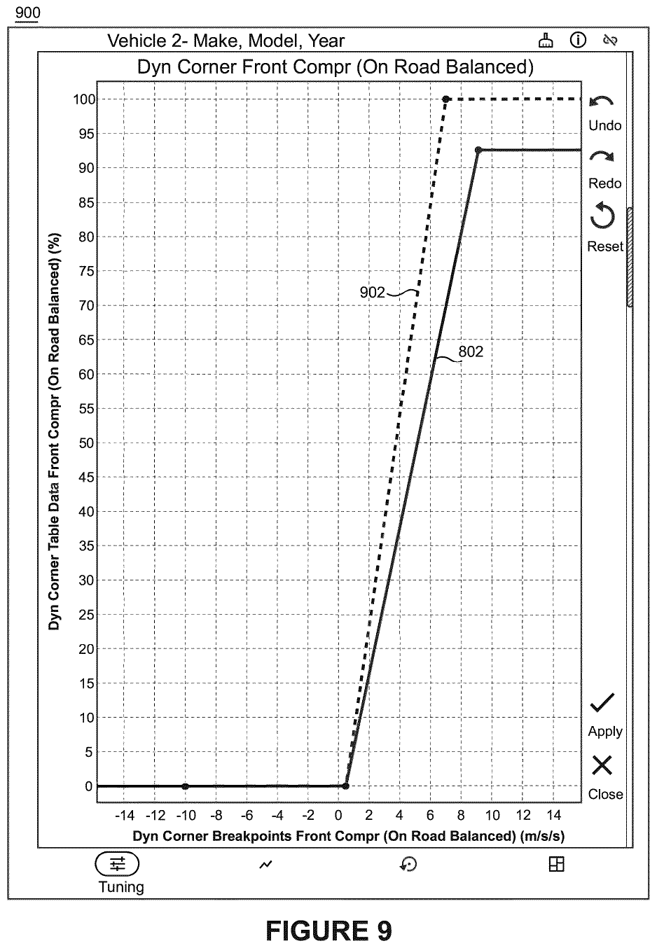

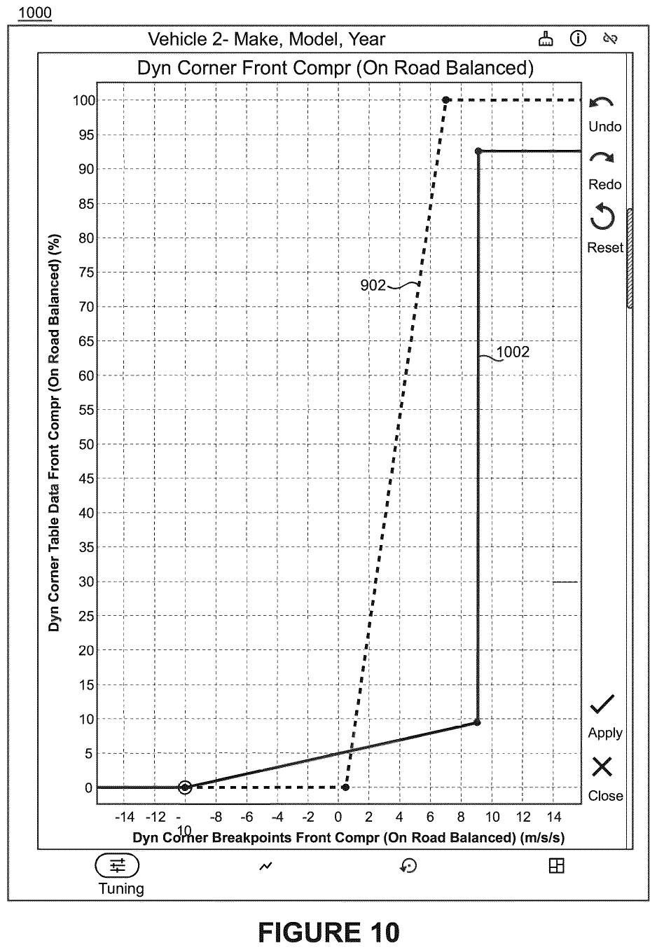

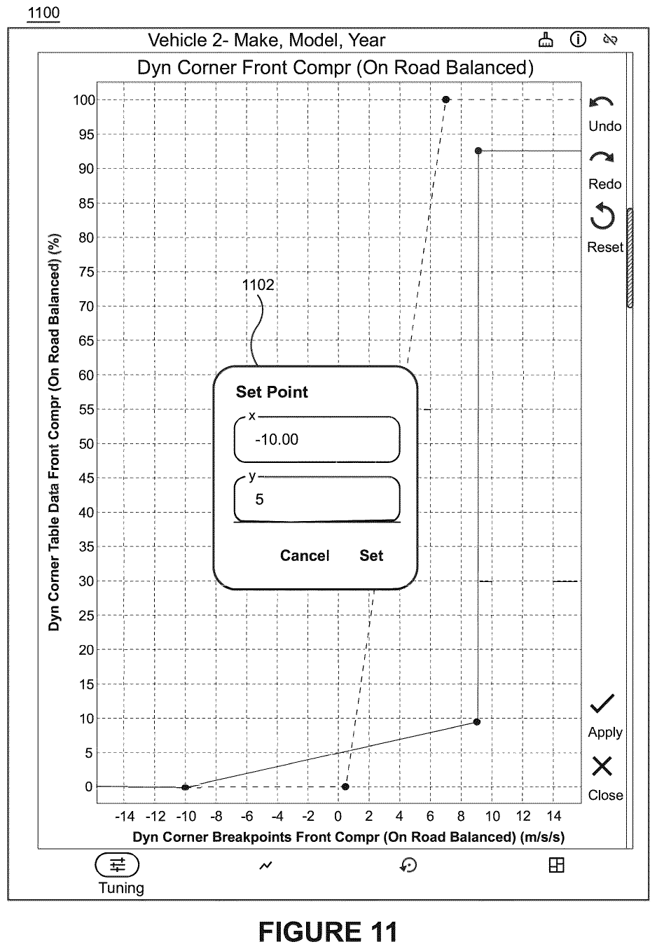

With reference now to FIGS. 8-11, the present parameter tuning tool 100 also provides a user with information corresponding to an aspect of the operation of a vehicle based upon a particular tuning of various vehicle parameters. Additionally, various embodiments of the present parameter tuning tool 100 also allow a user to readily determine how changes to the tuning of various vehicle parameters will affect an aspect of the operation of the vehicle. Specifically, UI 800 allows a user of the present parameter tuning tool 100 to visually analyze, adjust/tune and/or compare various vehicle parameters and their affect upon, for example, the operation of a front suspension of a vehicle. Such operational results of the front suspension of a vehicle (labeled Vehicle 1 in FIG. 8), based upon a particular tuning of one or more vehicle parameters, are indicated by line 802 in FIG. 8. Also, as shown in FIG. 8 (and also in UI 900 of FIG. 9, UI 1000 of FIG. 10 and UI 1100 of FIG. 11), UI 800 further allows a user of the present parameter tuning tool 100 to undo, redo, reset or apply the vehicle parameter tuning/settings and/or tune which resulted in the operational results represented by line 802 of FIG. 8.

With reference now to FIG. 9, as shown in UI 900, the present parameter tuning tool 100 also allows a user to readily compare operational results for different vehicles based upon a given tuning of various vehicle parameters. Specifically, UI 900 displays operational results of the front suspension of a vehicle (labeled Vehicle 2 in FIG. 9), based upon the same or similar tuning of one or more vehicle parameters applied to Vehicle 1 and whose operational results were previously indicated by line 802 in FIG. 8. The operational results of the front suspension of Vehicle 2 are indicated by line 902 in FIG. 9. Furthermore, as shown in FIG. 9, UI 900 also includes line 802 such that differences between the operational results for Vehicle 1 (line 802) and the operational results of Vehicle 2 (line 902), given the same or similar vehicle parameter settings/tuning, can be readily and visually determined by a user of the present parameter tuning tool 100.

With reference now to FIG. 10, as shown in UI 1000, and in a manner similar to that represented in FIG. 9, the present parameter tuning tool 100 also allows a user to readily compare operational results for different vehicles based upon a given tuning of various vehicle parameters. Specifically, UI 1000 displays operational results of the front suspension of a vehicle (labeled Vehicle 3 in FIG. 10), based upon the same or similar tuning of one or more vehicle parameters applied to Vehicle 2 and whose operational results were previously indicated by line 902 in FIG. 9. The operational results of the front suspension of Vehicle 3 are indicated by line 1002 in FIG. 10. Furthermore, as shown in FIG. 10, UI 1000 also includes line 902 such that differences between the operational results for Vehicle 2 (line 902) and the operational results of Vehicle 3 (line 1002), given the same or similar vehicle parameter settings/tuning, can be readily and visually determined by a user of the present parameter tuning tool 100.

It should further be noted that in various embodiments, the present parameter tuning tool 100 allows a user to readily compare operational results for the same vehicle but with a different tuning of the various vehicle parameters. In such an embodiment, a first tuning of one or more vehicle parameters is applied to, for example, Vehicle 1 and the operational results would be represented as shown by line 802 of FIG. 9. In such an embodiment, a second tuning of one or more vehicle parameters is applied to Vehicle 1 and the operational results would be represented as shown by line 902 of FIG. 9 such that differences between the operational results for the first tuning of Vehicle 1 (line 802) and the operational results for the second tuning of Vehicle 1 (line 902) can be readily and visually compared by a user of the present parameter tuning tool 100. Hence, the present parameter tuning tool 100 allows a user to visually analyze, adjust/tune and/or compare various vehicle parameters and their affect upon, for example, the operational results of a vehicle.

Now referring to FIG. 11, UI 1100 allows a user of the present parameter tuning tool 100 to visually analyze, adjust/tune and/or compare various vehicle parameters via, for example box 1102. Specifically, a user of the present parameter tuning tool 100 can examiner, for example, lines 902 and 1002 and, based upon their observation, the user of the present parameter tuning tool 100 can adjust, undo, redo, reset or apply the vehicle parameter tuning/settings and/or tune which provides a desired operational result. Additionally, the present parameter tuning tool 100, in various embodiments automatically sorts and renders information into the vehicle parameter tuning display (for example, the information or UIs presented in FIGS. 2A, 2B, 2C, 3A, 3B and 4-11). In so doing, initial and/or recent vehicle parameter values can be stored to enable an undo/redo functionality and/or to reset various vehicle parameters to a default behavior/level/state.

As mentioned above with respect to FIGS. 4-7, it should be noted that, although FIGS. 8-11 are provided as specific examples of UIs providing data corresponding to a particular tuning and/or predefined tune of various vehicle parameters, the present parameter tuning tool 100 is well suited to use with, or to generating, any of numerous types of UIs to provide data corresponding to a particular tuning and/or a predefined tune of various vehicle parameters. That is, the present parameter tuning tool 100 is not limited to use with only a single UI or with any specific type of UI for providing data corresponding to, or for adjusting/tuning of, a particular vehicle parameter tune and/or a setting for one or more vehicle parameters.

Moreover, should any vehicle, subsequent to the importation of the vehicle parameters, be altered in any way to any new configuration, the present parameter tuning tool 100 can be used to easily and efficiently re-tune or re-configure any prior vehicle parameters. That is, the present parameter tuning tool 100 is uniquely able to make adjustments based on a vehicle configuration in real time. Hence, the present parameter tuning tool 100 provides the unique solution to vehicle user's that regardless of any future vehicle modifications, the vehicle parameters can be readily adjusted such that the user is never confined to operating their vehicle with “stale” or less than optimal vehicle parameters. Additionally, the present parameter tuning tool 100 is well suited to creating appropriate parameter data libraries for future vehicles, vehicle makes and vehicle models.

In various embodiments of the present parameter tuning tool 100, communication is based on Fox's Connected Vehicle Protocol (CVP) over for example Bluetooth Low Energy (BLE). Additionally, in various embodiments of the present parameter tuning tool 100, via CVP, vehicle parameter information and the tuning UI(s) is queried and stored within its own vehicle parameter class within the present parameter tuning tool 100 and/or separate from the present parameter tuning tool 100.

Moreover, in various embodiments, the present parameter tuning tool 100 is able perform parameter configuration wirelessly. That is, in various embodiments, the present parameter tuning tool 100 does not require a hardwire connection or interface with the vehicle's ECU or with any vehicle parameter control application used with the vehicle. Moreover, in various embodiments, the present parameter tuning tool 100 operates over the air through, for example, a mobile infrastructure and/or a cloud infrastructure. In one embodiment, the present parameter tuning tool 100 can remotely configure/flash the vehicle ECU using the vehicle's vehicle identification (VIN) number.

Referring again to FIG. 1, the present parameter tuning tool 100, in various embodiments, will first import vehicle parameters to a testing module schematically shown as testing module 116. In various embodiments, testing module 116 is utilized to enable a user to visually analyze, adjust/tune and/or compare various vehicle parameters settings or vehicle parameter tunes as described above in the detailed description corresponding to, for example, FIGS. 2A, 2B, 2C, 3A, 3B and 4-11. Once the vehicle parameters are appropriately tuned and found acceptable, as described above, the vehicle parameters are then imported or “flashed” to, for example, a production electronic control unit (ECU) or any other vehicle control integrated circuit or module (schematically shown as production 118). Beneficially, in embodiments of the present parameter tuning tool 100, once the vehicle parameters are properly tuned, even if such tuning occurs on a different piece of hardware than the target or final ECU that will go into vehicle for production, the present parameter tuning tool 100 can be used to tune the actual ECU that will go into production. Therefore, the present parameter tuning tool 100, when a user proceeds to the production flash stage, eliminates the need for further validation of the production ECU.

Additionally, the present parameter tuning tool 100, in various embodiments, also provides vehicle parameter tuning firmware via, for example, Base Model 102 and/or specific vehicle data dictionaries/parameter libraries (e.g., vehicle 1 library 104 with data dictionaries 112 and/or vehicle 2 library 106 with data dictionaries 114) wherein the instructions or code contained therein is presented in a structure and with content which is very close to the content and structure of the production firmware. That is, various embodiments of the present parameter tuning tool 100 allow the tuning of vehicle parameters to be performed on firmware that is almost exactly the same as the version of firmware that will ultimately be utilized/released for production.

In various embodiments of the present parameter tuning tool 100, vehicle parameter changes made during the tuning process will happen in real time on, for example, the target ECU. Once sufficient vehicle parameter tuning configurations are exported and loaded into Base Model 102, a production flash is generated and is then deployed on the ECU or other module.

As stated above, once the calibration/tuning of vehicle parameters is completed, embodiments of the present parameter tuning tool 100 will ultimately export those vehicle parameters to the vehicle with the potential, in some embodiments, for a user of the vehicle to alter such vehicle parameters using vehicle parameter control application 108. As stated above, in one embodiment, the present parameter tuning tool 100 imports the vehicle parameters in the form of a comma-separated values (CSV) file, or any other suitable import file type, protocol or industry standard.

Another significant feature, is that the present parameter tuning tool 100 is well suited to operating with third parties. For example, assuming a user of the present parameter tuning tool 100 is only tuning vehicle parameters related to, for example, suspension components for an original equipment manufacturer (OEM) of a vehicle. If, however, the OEM also needs to have parameters tuned for other components, the present parameter tuning tool 100 can be used by, or in cooperation with, the provider of the other vehicle components to tune the parameters for the other vehicle components. As a result, the present parameter tuning tool 100 allows the OEM to work with only the present parameter tuning tool 100 to tune vehicle parameters for both the suspension component provider and the “other vehicle component” provider. Additionally, this benefit extends to end-users, as the end-users, using the present parameter tuning tool 100, can work with only the present parameter tuning tool 100 to tune vehicle parameters from multiple vehicle component providers. Hence, the present parameter tuning tool 100 allows customers the benefit of utilizing software supplied by one source, i.e., the provider of the present parameter tuning tool 100, to tune vehicle parameters corresponding to vehicle components from multiple vehicle component providers.

Yet another significant feature, is that the present parameter tuning tool 100 is well suited to preventing parameter conflicts. For example, assuming that a suspension component provider determines that 15 suspension component parameters are necessary to populate the present parameter tuning tool 100. Further assuming that the first engineering group is responsible for providing ranges of possible parameter values for suspension parameters 1-5, the second engineering group is responsible for providing ranges of possible parameter values for suspension parameters 6-10, and the third engineering group is responsible for providing ranges of possible parameter values for suspension parameters 11-15. In various embodiments, the present parameter tuning tool 100 will identify any conflicts between the ranges of possible parameter values provided by the three engineering groups. In so doing, the present parameter tuning tool 100 enables the three engineering groups to resolve such conflicts prior to utilizing the present parameter tuning tool 100 with, for example, an OEM. As such, the present parameter tuning tool 100 eliminates “downstream” issues due to internal or native inconsistencies. Thus, the present parameter tuning tool 100 provides guardrails even as the parameter libraries are being generated

Additionally, the present parameter tuning tool 100 enables a vehicle parameter control application to be automatically configured with tuning parameters selected on a per-vehicle parameter control application basis. In embodiments of the present parameter tuning tool 100, tuning parameters are exposed to a user of the present parameter tuning tool 100, and such tuning of vehicle parameters are well defined by the Base Model 102 provided in the present parameter tuning tool 100. Hence, the present parameter tuning tool 100 enables tuning of vehicle parameters to be quickly performed and to be configured for any vehicle parameter control application.

In various embodiments, the present parameter tuning tool 100 also combines various vehicle parameter tuning aspects with, for example, real-time telemetry display, and also provides a system for saving, importing, and exporting previously used vehicle parameter tunes. The combination of these features, as provided by the present parameter tuning tool 100 significantly decreases the vehicle parameter tuning time required by each type of vehicle parameter control application by eliminating the need for configuring redundant screens and/or by eliminating the need for expensive hardware typically required for real-time telemetry displays. Further, various embodiments of the present parameter tuning tool 100 utilize widgets for real-time telemetry streaming.

As yet another beneficial feature, in various embodiments, the present parameter tuning tool 100 has a parameter data structure and an application UI which is stored within and/or defined by Base Model 102. That is, in some embodiments of the present parameter tuning tool 100, an application UI (e.g., the UIs of FIGS. 2A, 2B, 2C, 3A, 3B and 4-11) is built from parameters exposed by the Base Model 102. Is such embodiments, the present parameter tuning tool 100 is able to reconfigure itself on a per vehicle parameter basis and/or on a per vehicle parameter control application basis. Thus, the Base Model 102 architecture of the present parameter tuning tool 100 enables an easily generated and appropriately configured system and corresponding UIs for the tuning of vehicle parameters. Specifically, in various embodiments of the present parameter tuning tool 100, an application UI (e.g., the UIs of FIGS. 2A, 2B, 2C, 3A, 3B and 4-11) is composed in real-time, based upon the vehicle parameter set (e.g., data dictionaries 112 of vehicle 1 library 104, and as data dictionaries 114 of vehicle 2 library 106) being exposed by the Base Model 102. As a result, the UIs and various features generated by the present parameter tuning tool 100 for vehicle 1 may look completely or partially different from the UIs and various features generated by the present parameter tuning tool 100 for vehicle 2. Such complete or partial differences, in various embodiments, result from the present parameter tuning tool 100, for example, composing its UIs and various features for vehicle 1 based upon Base Model 102 interacting with data dictionaries 112 and library 104, however, for vehicle 2, the present parameter tuning tool 100 composes its UIs and various features based upon Base Model 102 interacting with data dictionaries 114 and library 106.

In various embodiments of the present parameter tuning tool 100, the common Base Model 102 eliminates the need for hardcoded application specific parameters, as such application specific parameters can instead be stored, for example, in specialized containers such as, but not limited to, data dictionaries 112 of vehicle 1 library 104, and as data dictionaries 114 of vehicle 2 library 106. Additionally, in various embodiments of the present parameter tuning tool 100, data transfer of, for example, vehicle parameter settings may be implemented via controller area network (CAN). The present parameter tuning tool 100, in various embodiments, will also include access restrictions/permissions (or user levels) which require corresponding user credentials such that different configurations of user access to tunable parameters (or any other feature of the present parameter tuning tool 100) can be strictly controlled.

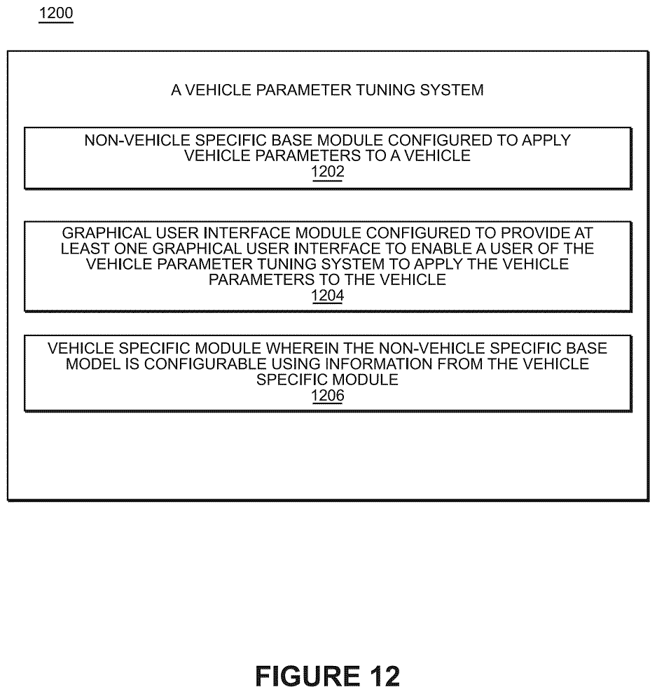

FIG. 12 is a schematic diagram of a vehicle parameter tuning system 1200 which graphically illustrates and summarizes various features and components of the present parameter tuning tool 100. More specifically, vehicle parameter tuning system 1200 of FIG. 12 is comprised of a non-vehicle specific base module schematically represented as 1202 in FIG. 12 and shown as 102 in FIG. 1. As described above in detail, the non-vehicle specific base model 102 is configurable for use with a specific version of a vehicle and is configured to apply parameters to a vehicle.

Vehicle parameter tuning system 1200 of FIG. 12 is further comprised of a graphical user interface module 1204. Graphical user interface module 1204 is configured to provide at least one graphical user interface to enable a user of the vehicle parameter tuning system of the present parameter tuning tool 100 to apply/tune vehicle parameters for a vehicle. As mentioned above, in various embodiments of the present parameter tuning tool 100, an application UI (e.g., the UIs of FIGS. 2A, 2B, 2C, 3A, 3B and 4-11) is built from parameters exposed by the Base Model 102 and provided to graphical user interface module 1204. Also, in various embodiments of the present parameter tuning tool 100, and as described above, graphical user interface module 1204 will utilize an application UI comprised of source code stored in a mobile application and/or a tablet application.

Vehicle parameter tuning system 1200 of FIG. 12 is further comprised of a vehicle specific module schematically represented as 1206 in FIG. 12 and shown in FIG. 1 as data dictionaries 112 in vehicle 1 library 104, and as data dictionaries 114 in vehicle 2 library 106. Vehicle specific module 1206 will, in various embodiments include or utilize, for example, data dictionaries as schematically depicted in FIG. 1 as data dictionaries 112 in vehicle 1 library 104, and as data dictionaries 114 in vehicle 2 library 106. In various embodiments of the present parameter tuning tool 100, vehicle specific module 1206 of FIG. 12 is utilized in conjunction with the non-vehicle specific base model 102 to ultimately apply parameters to a specific version of a vehicle as is described above in detail.

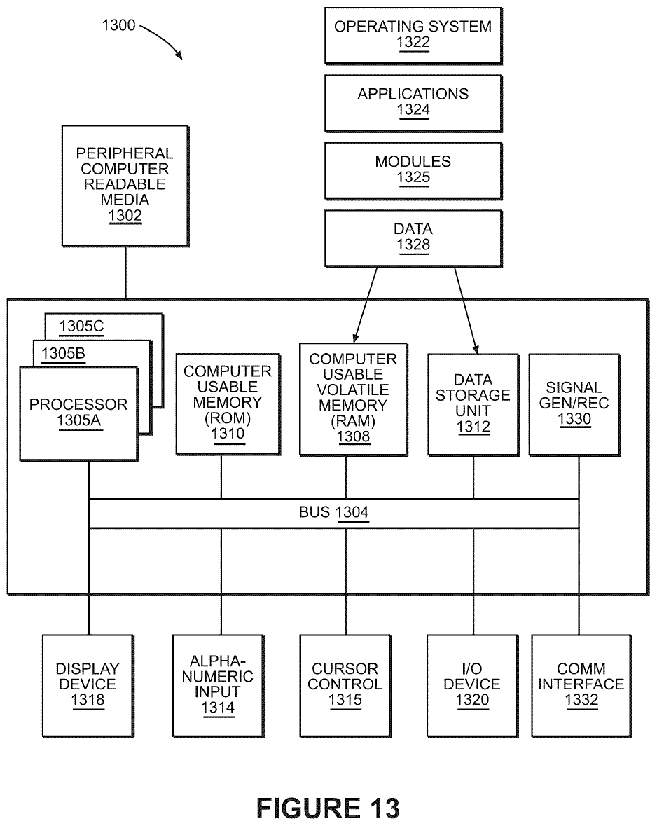

With reference now to FIG. 13, a computer system 1300 shown in accordance with one embodiment. In the following discussion, computer system 1300 is representative of a computer system or components of a computer system that may be used with aspects of the present technology. For example, one or more components of the present parameter tuning tool 100 may utilize one or more components disclosed in computer system 1300. In one embodiment, different computing embodiments will only use some of the components shown in computer system 1300.

For example, any or all of non-vehicle specific base model 102, graphical user interface module 1204, and vehicle specific module 1206 can include some or all of the components of computer system 1300. In various embodiments the present parameter tuning tool 100 of FIG. 1 can include communication capabilities (e.g., wired such as ports or the like, and/or wirelessly such as near field communication, Bluetooth, WiFi, or the like) such that some of the components of computer system 1300 are found on the present parameter tuning tool 100 while other components could be ancillary but communicatively coupled thereto (such as a mobile device, tablet, computer system or the like).

For example, in one embodiment, the present parameter tuning tool 100 can be communicatively coupled to one or more different computing systems to allow a user (or manufacturer, tuner, technician, etc.) to adjust or modify any or all of various vehicle parameters. In one embodiment, the programming includes computer-readable and computer-executable instructions that reside, for example, in non-transitory computer-readable medium (or storage media, etc.) of the present parameter tuning tool 100 and/or computer system 1300.

In one embodiment, computer system 1300 includes an address/data/control bus 1304 for communicating information, and a processor 1305A coupled to bus 1304 for processing information and instructions. As depicted in FIG. 13, computer system 1300 is also well suited to a multi-processor environment in which a plurality of processors 1305A, 1305B, and 1305C are present. Conversely, computer system 1300 is also well suited to having a single processor such as, for example, processor 1305A. Processors 1305A, 1305B, and 1305C may be any of various types of microprocessors. Computer system 1300 also includes data storage features such as a computer usable volatile memory 1308, e.g., random access memory (RAM), coupled to bus 1304 for storing information and instructions for processors 1305A, 1305B, and 1305C.

Computer system 1300 also includes computer usable non-volatile memory 1310, e.g., read only memory (ROM), coupled to bus 1304 for storing static information and instructions for processors 1305A, 1305B, and 1305C. Also present in computer system 1300 is a data storage unit 1312 (e.g., a magnetic disk drive, optical disk drive, solid state drive (SSD), and the like) coupled to bus 1304 for storing information and instructions. Computer system 1300 also can optionally include an alpha-numeric input device 1314 including alphanumeric and function keys coupled to bus 1304 for communicating information and command selections to processor 1305A or processors 1305A, 1305B, and 1305C. Computer system 1300 also can optionally include a cursor control device 1315 coupled to bus 1304 for communicating user input information and command selections to processor 1305A or processors 1305A, 1305B, and 1305C. Cursor control device may be a touch sensor, gesture recognition device, and the like. Computer system 1300 of the present embodiment can optionally include a display device 1318 coupled to bus 1304 for displaying information.

Referring still to FIG. 13, display device 1318 of FIG. 13 may be a liquid crystal device, cathode ray tube, OLED, plasma display device or other display device suitable for creating graphic images and alpha-numeric characters recognizable to a user. Cursor control device 1315 allows the computer user to dynamically signal the movement of a visible symbol (cursor) on a display screen of display device 1318. Many implementations of cursor control device 1315 are known in the art including a trackball, mouse, touch pad, joystick, non-contact input, gesture recognition, voice commands, bio recognition, and the like. In addition, special keys on alpha-numeric input device 1314 capable of signaling movement of a given direction or manner of displacement. Alternatively, it will be appreciated that a cursor can be directed and/or activated via input from alpha-numeric input device 1314 using special keys and key sequence commands.

Computer system 1300 is also well suited to having a cursor directed by other means such as, for example, voice commands. Computer system 1300 also includes an I/O device 1320 for coupling computer system 1300 with external entities. For example, in one embodiment, I/O device 1320 is a modem for enabling wired or wireless communications between computer system 1300 and an external network such as, but not limited to, the Internet or intranet. A more detailed discussion of the present technology is found below.

Referring still to FIG. 13, various other components are depicted for computer system 1300. Specifically, when present, an operating system 1322, applications 1324, modules 1325, and data 1328 are shown as typically residing in one or some combination of computer usable volatile memory 1308, e.g., random-access memory (RAM), and data storage unit 1312. However, it is appreciated that in some embodiments, operating system 1322 may be stored in other locations such as on a network or on a flash drive; and that further, operating system 1322 may be accessed from a remote location via, for example, a coupling to the Internet. The present technology may be applied to one or more elements of computer system 1300.

Computer system 1300 also includes one or more signal generating and receiving device(s) 1330 coupled with bus 1304 for enabling computer system 1300 to interface with other electronic devices and computer systems. Signal generating and receiving device(s) 1330 of the present embodiment may include wired serial adaptors, modems, and network adaptors, wireless modems, wireless network adaptors, and other such communication technology. The signal generating and receiving device(s) 1330 may work in conjunction with one (or more) communication interface 1332 for coupling information to and/or from computer system 1300. Communication interface 1332 may include a serial port, parallel port, Universal Serial Bus (USB), Ethernet port, Bluetooth, thunderbolt, near field communications port, WiFi, Cellular modem, or other input/output interface. Communication interface 1332 may physically, electrically, optically, or wirelessly (e.g., via radio frequency) be used to communicatively couple computer system 1300 with another device, such as a mobile phone, radio, or computer system.

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the Claims.

Reference throughout this document to “one embodiment,” “certain embodiments,” “an embodiment,” “various embodiments,” “some embodiments,” “various embodiments”, or similar term, means that a particular feature, structure, or characteristic described in connection with that embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What we claim is:

1. A vehicle parameter tuning system comprising:
a non-vehicle specific base model, said non-vehicle specific base model configured to apply parameters to a vehicle;
a graphical user interface module, said graphical user interface module configured to provide at least one graphical user interface to enable a user of said vehicle parameter tuning system to apply said parameters to said vehicle; and
wherein said non-vehicle specific base model is configurable for use with a specific version of said vehicle.

2. The vehicle parameter tuning system of claim 1, wherein said non-vehicle specific base model is configurable for use with a second vehicle.

3. The vehicle parameter tuning system of claim 2, wherein said non-vehicle specific base model is configurable for use with a specific version of said second vehicle.

4. The vehicle parameter tuning system of claim 1, wherein said graphical user interface module is configured to provide at least one graphical user interface to enable said user of said vehicle parameter tuning system to apply said parameters to said specific version of said vehicle.

5. The vehicle parameter tuning system of claim 2, wherein said graphical user interface module is configured to provide at least one graphical user interface to enable said user of said vehicle parameter tuning system to apply said parameters to said second vehicle.

6. The vehicle parameter tuning system of claim 5, wherein said graphical user interface module is configured to provide at least one graphical user interface to enable said user of said vehicle parameter tuning system to apply said parameters to said specific version of said second vehicle.

7. The vehicle parameter tuning system of claim 1, wherein said graphical user interface module is configured to provide at least one graphical user interface to enable said user of said vehicle parameter tuning system to observe vehicle operation results based upon said parameters being applied to said vehicle.

8. The vehicle parameter tuning system of claim 1, wherein said graphical user interface module is configured to provide at least one graphical user interface to enable said user of said vehicle parameter tuning system to observe vehicle operation results based upon said parameters being applied to said specific version of said vehicle.

9. The vehicle parameter tuning system of claim 1, wherein said graphical user interface module is configured to provide at least one graphical user interface to enable said user of said vehicle parameter tuning system to alter said parameters being applied to said vehicle.

10. The vehicle parameter tuning system of claim 1, wherein said graphical user interface module is configured to provide at least one graphical user interface to enable said user of said vehicle parameter tuning system to alter said parameters being applied to said specific version of said vehicle.

11. The vehicle parameter tuning system of claim 2, wherein said graphical user interface module is configured to provide at least one graphical user interface to enable said user of said vehicle parameter tuning system to alter said parameters being applied to said second vehicle.

12. The vehicle parameter tuning system of claim 11, wherein said graphical user interface module is configured to provide at least one graphical user interface to enable said user of said vehicle parameter tuning system to alter said parameters being applied to said specific version of said second vehicle.

13. A vehicle suspension parameter tuning system comprising:
a non-vehicle specific base model, said non-vehicle specific base model configured to apply suspension parameters to a vehicle;
a graphical user interface module, said graphical user interface module configured to provide at least one graphical user interface to enable tuning of said vehicle suspension parameter tuning system to apply said suspension parameters to said vehicle; and
wherein said non-vehicle specific base model is configurable for use with a specific version of said vehicle.

14. The vehicle suspension parameter tuning system of claim 13, wherein said non-vehicle specific base model is configurable for use with a second vehicle.

15. The vehicle suspension parameter tuning system of claim 14, wherein said non-vehicle specific base model is configurable for use with a specific version of said second vehicle.

16. The vehicle suspension parameter tuning system of claim 13, wherein said graphical user interface module is configured to provide at least one graphical user interface to enable a user of said vehicle suspension parameter tuning system to apply said suspension parameters to said specific version of said vehicle.

17. The vehicle suspension parameter tuning system of claim 14, wherein said graphical user interface module is configured to provide at least one graphical user interface to enable a user of said vehicle suspension parameter tuning system to apply said suspension parameters to said second vehicle.

18. The vehicle suspension parameter tuning system of claim 13, wherein said graphical user interface module is configured to provide at least one graphical user interface to enable a user of said vehicle suspension parameter tuning system to observe vehicle operation results based upon said suspension parameters being applied to said vehicle.

19. The vehicle parameter tuning system of claim 13, wherein said graphical user interface module is configured to provide at least one graphical user interface to enable a user of said vehicle to alter said suspension parameters previously applied to said vehicle.

20. A vehicle parameter tuning system comprising:
a non-vehicle specific base model, said non-vehicle specific base model configured to apply parameters to a vehicle;
a graphical user interface module, said graphical user interface module configured to provide at least one graphical user interface to enable a user of said vehicle parameter tuning system to apply said parameters to said vehicle;
a library of said parameters for said vehicle;
wherein said at least one graphical user interface is pre-defined in said non-vehicle specific base model and/or in said library of said parameters for said vehicle;
wherein said at least one graphical user interface is automatically generated in real-time without requiring additional actions to link said at least one graphical user interface to said parameters of said vehicle; and
wherein said non-vehicle specific base model is configurable for use with a specific version of said vehicle.
